(19) United States
(12) Patent Application Publication
(10) Pub. No.: US 2016/0003663 A1
(43) Pub. Date: Jan. 7, 2016

(54) CAPACITIVE LIQUID LEVEL MEASUREMENT WITH DIFFERENTIAL OUT-OF-PHASE CHANNEL DRIVE TO COUNTERACT HUMAN BODY CAPACITANCE

(71) Applicant: Texas Instruments Incorporated, Dallas, TX (US)

(72) Inventors: Daniele Miatton, Carbonara al Ticino (IT); Athos Canclini, Cernobbio (IT); Dongtai Liu, Fremont, CA (US); Evgeny Fomin, San Carlos, CA (US); George Reitsma, Redwood City, CA (US); Riccardo Tarelli, Calolziocorte (IT)

(21) Appl. No.: 14/790,355

(22) Filed: Jul. 2, 2015

Related U.S. Application Data
(60) Provisional application No. 62/020,725, filed on Jul. 3, 2014.

(51) Int. Cl. G01F 23/26

(52) U.S. Cl. CPC G01F 23/263

(57) ABSTRACT

Capacitive liquid level measurement uses differential out-of-phase (OoP) channel drive to counteract human body capacitance. In an example embodiment, a container assembly includes a capacitive sensor with symmetrical CHx and CHy capacitor electrodes, corresponding in height to a liquid level measurement range. A CHx driver provides a CHx excitation/drive to the CHx electrode, and a CHy driver provides OoP CHy excitation/drive to the CHy electrode that is substantially 180 degrees out-of-phase with the CHx drive. Capacitance associated with the liquid level is measured by acquiring capacitance measurements through the CHx channel (such as based on capacitive charge transfer), and converting the capacitance measurements to an analog voltage corresponding to liquid-level capacitance (which can then be converted to digital data). The capacitive sensor can be configured with SHLDx/SHLDy shields disposed behind, and driven in phase with, respective CHx/CHy electrodes.

### CROSS-REFERENCE TO RELATED APPLICATIONS

Priority is claimed under USC §119(e) to U.S. Provisional Application 62/020725 (Docket TI-75261PS), filed Jul. 3, 2014.

### BACKGROUND

1. Technical Field

This Patent Document relates generally to measuring liquid level in a container.

2. Related Art

Capacitive sensing technology has been adapted for sensing liquid levels. Capacitive sensing is contactless, and wear-free.

For liquid levels, a container assembly includes an external capacitive sensor (capacitor electrodes) dimensioned according to a predetermine liquid level range. Ignoring environmental factors, such as parasitic capacitances, measured capacitance increases linearly as liquid level increases.

### BRIEF SUMMARY

This Brief Summary is provided as a general introduction to the Disclosure provided by the Detailed Description and Drawings, summarizing some aspects and features of the Disclosure. It is not a complete overview of the Disclosure, and should not be interpreted as identifying key elements or features of the invention, or otherwise characterizing or delimiting the scope of the invention disclosed in this Patent Document.

The Disclosure describes apparatus and methods for capacitive liquid level measurement with differential out-of-phase (OoP) channel drive counteracting human body capacitance.

According to aspects of the Disclosure, capacitive liquid level measurement with differential out-of-phase (OoP) channel drive can be adapted for use in a liquid container assembly in which a capacitive sensor disposed adjacent the container includes CHx and CHy symmetrical capacitor electrodes, each corresponding in height to a range of liquid level measurement. The OoP capacitive liquid level methodology includes: driving the CHx electrode with a CHx drive signal; driving the CHy electrode with a CHy drive signal that is substantially 180 degrees out-of-phase with the CHx drive signal; acquiring capacitance measurements through the CHx electrode (such as based on capacitive charge transfer); and converting the capacitance measurements to an analog voltage corresponding to the capacitance associated with the liquid level. The methodology can include converting the analog capacitance measurements to digital data corresponding to the capacitance associated with the liquid level.

Other aspects and features of the invention claimed in this Patent Document will be apparent to those skilled in the art from the following Disclosure.

### BRIEF DESCRIPTION OF THE DRAWINGS

FIGS. 1A, 1B, 1C, 1D functionally illustrate capacitive liquid level measurement adapted to a liquid container assembly with CHx and GND capacitor electrodes (20_A and 20_B), and capacitance measurement electronics (40), and including a container/liquid electrical model (FIGS. 2 and 3) with container capacitance Cp and liquid capacitance/resistance Cw/Rw.

FIGS. 2A, 2B, 2C functionally illustrate capacitive liquid level measurement where a human body presence (represented by hand 50), is brought into proximity with the container/liquid (11/13), introducing parasitic capacitance: FIG. 2B illustrates the container/liquid electrical model (30) with human body capacitance Ch coupled into a capacitance measurement node (LIQ); and FIG. 2C illustrates an example capacitance measurement plot with the effect of human body capacitance on capacitance measurement illustrated as a parasitic disturbance (55) in the measured capacitance.

FIGS. 3A, 3B, 3C illustrate an example functional embodiment of capacitive liquid level measurement with differential out-of-phase (OoP) channel drive to counteract human body capacitance: FIG. 3A illustrates a liquid container system including CHx and CHy capacitor electrodes 21x and 21y; and FIG. 3C illustrates an example functional embodiment of OoP capacitive liquid level measurement, including capacitance-to-digital conversion (CDC) electronics (40) with differential CHx and OoP CHy sensor excitation/acquisition channels, coupled to the container/liquid electrical model (30) including human body capacitance Ch.

### DETAILED DESCRIPTION

This Description and the Drawings constitute a Disclosure of example embodiments and applications that illustrate various features and advantages of capacitive liquid level measurement with differential out-of-phase (OoP) channel drive to counteract human body capacitance.

In brief overview, the Disclosed system/methodology for capacitive liquid level measurement uses differential out-of-phase (OoP) channel drive to counteract human body capacitance. In an example embodiment, a container assembly includes a capacitive sensor with symmetrical CHx and CHy capacitor electrodes, corresponding in height to a liquid level measurement range. A CHx driver provides CHx excitation/drive to the CHx electrode, and a CHy driver provides OoP CHy excitation/drive to the CHy electrode that is substantially 180 degrees out-of-phase with the CHx drive. Capacitance associated with the liquid level is measured by acquiring capacitance measurements through the CHx channel (such as based on capacitive charge transfer), and converting the capacitance measurements to an analog voltage corresponding to liquid-level capacitance (which can then be converted to digital data representative of liquid level). The CHx/CHy capacitive sensor can be configured with SHLDx/SHLDy shields disposed behind, and driven in phase with, respective CHx/CHy electrodes. Example applications include appliances (refrigerators, coffee machines, humidifiers), and medical (auto-injectors, drug pens, insulin pumps).

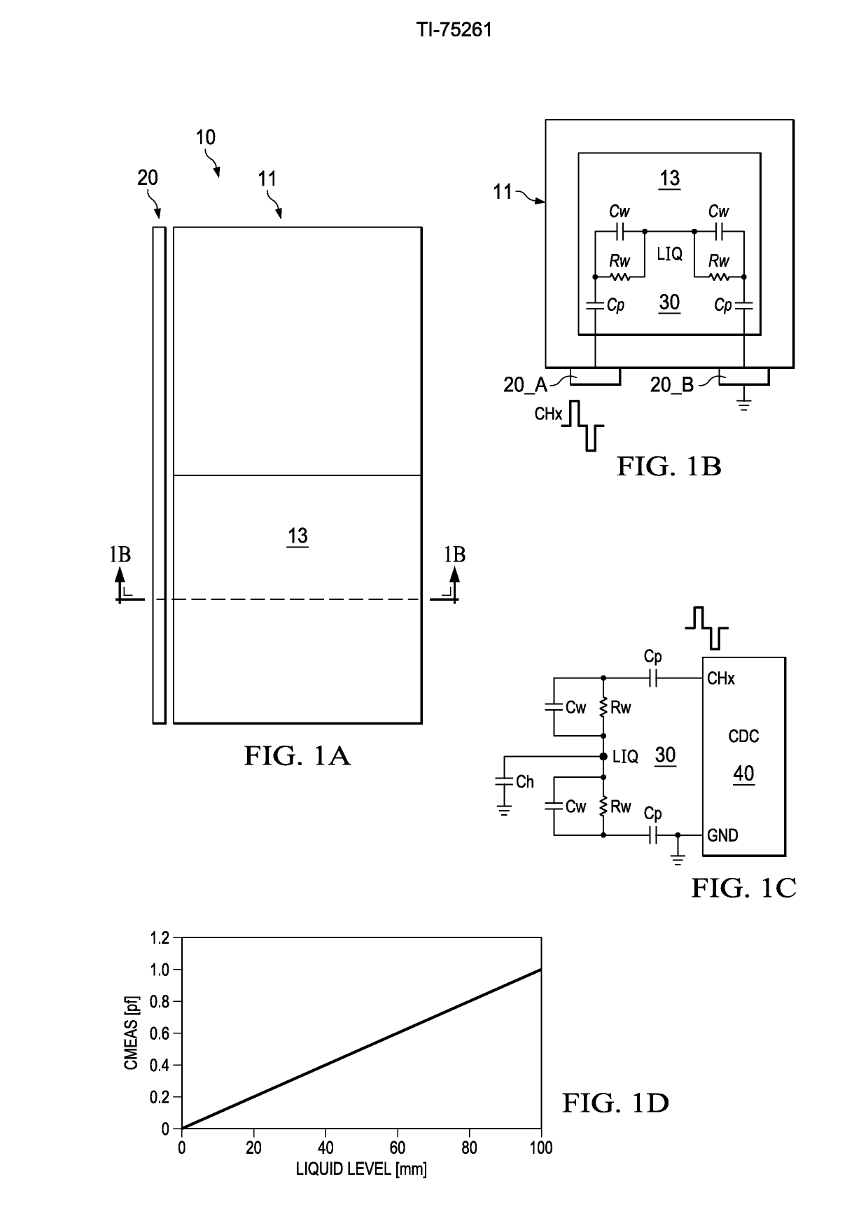

FIGS. 1A, 1B, 1C, 1D functionally illustrate capacitive liquid level measurement in connection with a liquid container assembly 10, that includes a container 11 with a liquid 13, such as water.

A capacitive liquid level measurement system is represented by capacitive sensing electrodes 20 (FIG. 1A), comprising (FIG. 1B) symmetrical channel electrode (CHx) 20_A and ground electrode (GND) 20_B. Capacitive measurement electronics is represented by a capacitance-to-digital converter (CDC) 40. A container/liquid electrical model 30 includes a capacitance Cp of container 11 and capacitance/resistance Cw/Rw of liquid/water 13.

Capacitive sensing is based on successive excitation/drive and acquisition/read phases through CHx channel electrode 20_A. During acquisition/read phases, fringing capacitance is measured between the CHx channel electrode 20_A and GND electrode 20_B. In container/liquid electrical model 30, capacitance is measured relative to node LIQ.

Referring to FIG. 1D, measured capacitance increases linearly as liquid level.

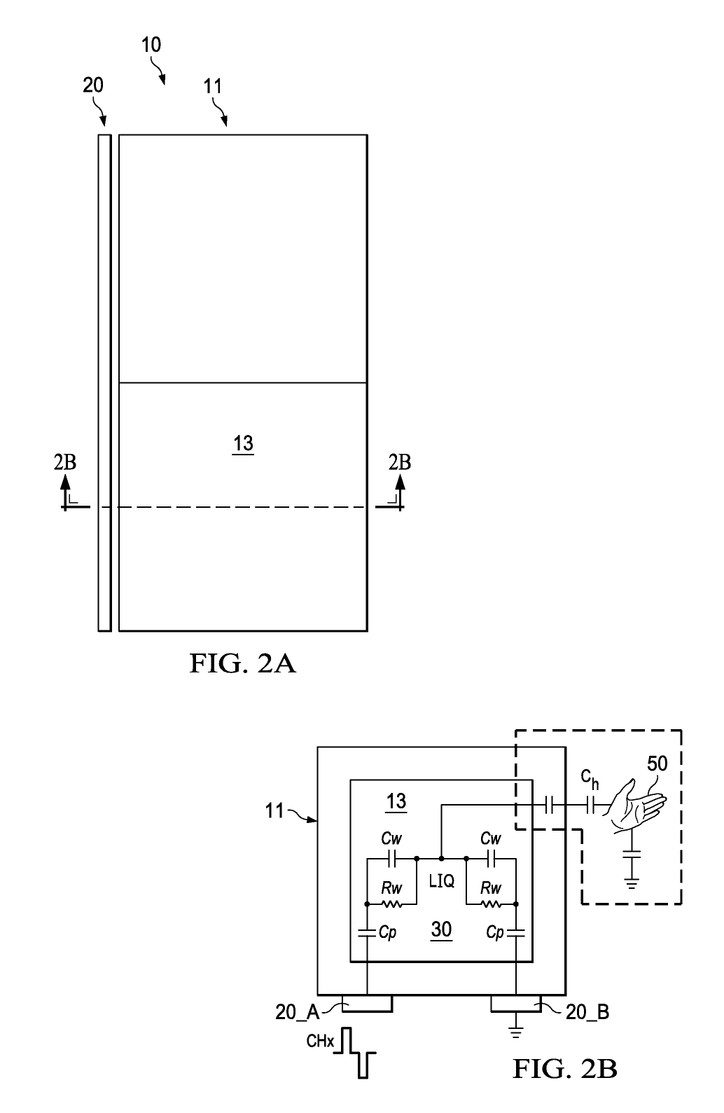

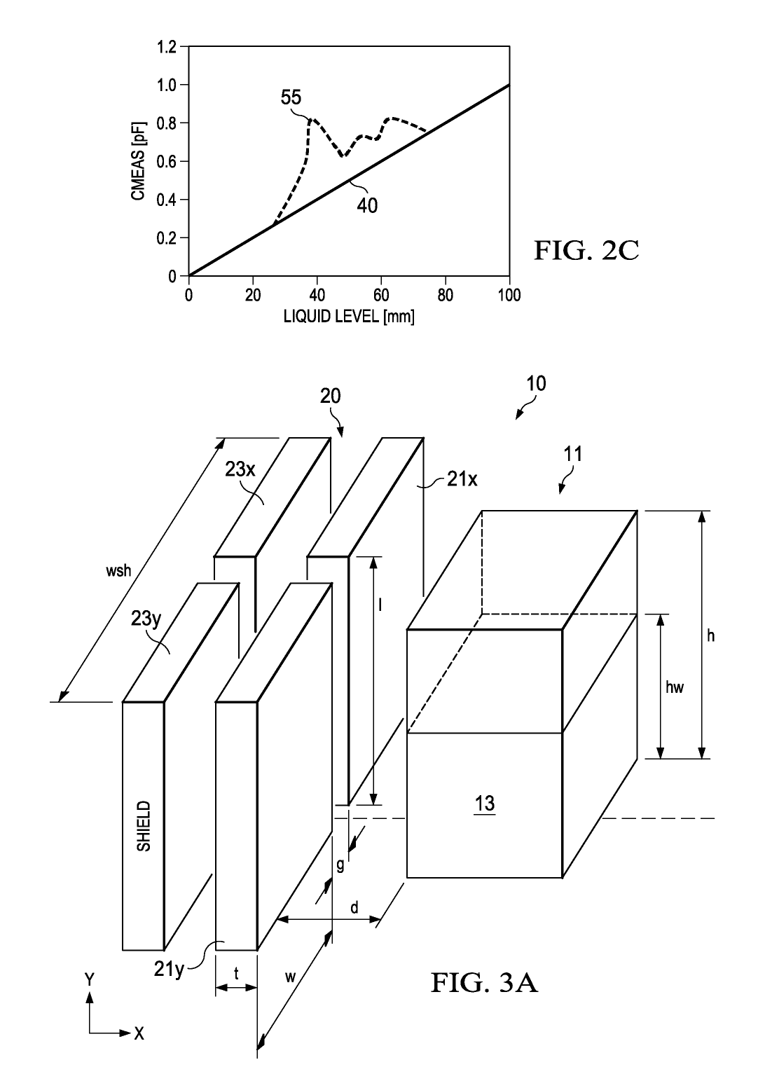

FIGS. 2A, 2B, 2C functionally illustrate capacitive liquid level measurement for container system 10 where a human body presence, functionally represented by hand 50, is brought into proximity with liquid 13 in container 11. The human body presence introduces parasitic capacitances, represented in container/liquid electrical model 30 as capacitance Ch that couples into the capacitance measurement node LIQ.

Referring to FIG. 2C, the potential difference caused by the parasitic human body capacitance Ch corresponds to a disturbance 55 in the measured capacitance, affecting the liquid level measurement.

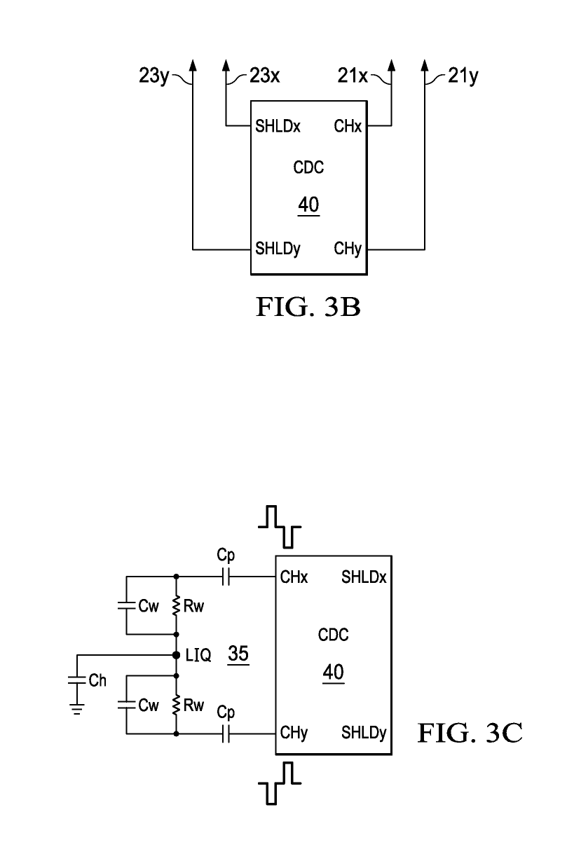

FIGS. 3A, 3B, 3C illustrates an example functional embodiment of capacitive liquid level measurement with differential out-of-phase (OoP) channel drive, effective to counteract human body capacitance, according to aspects of this Disclosure.

Referring to FIG. 3A, a liquid container system 10 includes container 11 with liquid 13, such as water. A capacitive sensor assembly 20 is disposed adjacent container 11. Capacitive sensor assembly 20 includes symmetrical, separately driven CHx and OoP CHy capacitor electrodes 21x and 21y, each corresponding in height to a range of liquid level measurement.

The example capacitive sensor assembly 20 is configured with driven shields that focus the sensing direction toward the liquid target, and provide a backside barrier from interference that can affect capacitance measurements. SHLDx shield 23x is arranged behind the CHx electrode, and a SHLDy shield 23y is arranged behind the CHy electrode. SHLDx/SHLDy shields 23X/23y are driven in phase with respective CHx/CHy electrodes 21x/21y, i.e., with the same excitation/drive signal as the CHx/CHy electrodes. Because SHLDx/SHLDy are at substantially the same potential as the CHx/CHy electrodes, electric field is canceled on the shield side of capacitive sensor assembly 20, so that the active sensing e-field is in the direction of the liquid.

Referring to FIGS. 3B and 3C, the liquid is represented by container/liquid electrical model 30, including container capacitance Cp and water capacitance/resistance Cw/Rw. Parasitic human body capacitance is represented by Ch coupled into capacitance measurement node LIQ.

For this example embodiment, capacitance measurement electronics is illustrated as a CDC 40, including sensor measurement channels CHx and CHy. The CHx channel is coupled to the CHx electrode 21x, and the CHy channel is coupled to the CHy electrode. Shield drive is through SHLDx/SHLDy shield driver outputs.

CDC 40 is configured to measure capacitance associated with the liquid level in the container, providing excitation/drive and acquisition/read phases. CDC 40 can be configured to implement capacitive sensing based on capacitive charge transfer—in successive charge transfer phases (excitation/acquisition), charge is transferred from the CHx/CHy capacitor electrodes 21x/21y into CDC 40 (such as to a charge transfer capacitor), generating an analog voltage that corresponds to the measured capacitance associated with liquid level.

For differential OoP capacitive sensing according to aspects of this Disclosure, CDC 40 drives CHx electrode 21x through the CHx channel with a CHx drive signal, and drives CHy electrode 21y through the CHy channel with a CHy drive signal that is substantially 180 degrees out-of-phase to the CHx drive signal.

CDC 40 acquires capacitance measurements through the CHx, which can be referenced to ground or another fixed voltage. In terms of the electrical model, capacitance is measured at the capacitance measurement node LIQ. Differential OoP sensor drive effectively fixes the voltage potential at the LIQ node, counteracting any human body parasitic capacitance.

Referring to FIG. 3A, capacitance can be measured according to C_{MEAS} a h_{w}e_{w}+(h−h_{w})eₐ, where: h=container height; h_{w}=height of liquid; e_{w}=dielectric of liquid; and eₐ=dielectric of air.

CDC 40 also includes shield drivers, providing shield drive through the SHLDx/SHLDy outputs coupled respectively to SHLDx/SHLDy shields 23x23y. CDC 40 is configured to drive the SHLDx shield 23x with a SHLDx signal in phase with the CHx electrode channel drive, and to drive the SHLDy shield with a SHLDy signal in phase with the CHy electrode channel drive.

For the example embodiment, CDC 40 is configured to convert the analog capacitance measurements to digital data, corresponding to measured capacitance representing liquid level. To perform conversion, CDC 40 can be configured with an analog-to-digital converter such as a sigma delta converter. CDC 40 can also include digital filtering with digital data correction based on gain and/or offset calibrations.

For example, CDC 40 (capacitance measurement electronics) can be configured with an AFE (analog front end), and an ADC (analog-to-digital converter). The AFE can be configured to drive the CHx and CHy electrodes through the CHx and CHy channels, and acquire analog capacitance measurements through the CHx channel (such as based on capacitive charge transfer). The ADC can be configured to convert analog capacitance measurements to digital data corresponding to the capacitance associated with the liquid level.

As a design example, the following table provides example capacitive liquid level measurements for liquid levels L1 and L2=L1+3.5 cm, each measured at four different human body (hand) positions relative to a container: (a) C0—no hand; (b) C2 cm—hand at 2 cm from the container; (c) C1 cm—hand at 1 cm from the container; and (c) Chand—hand in contact with container. As illustrated, Differential OoP channel drive is substantially insensitive to the presence of human body capacitance.

| | Capacitance | | | | Error | | | |
|---|---|---|---|---|---|---|---|---|
| | Level | | | | | | | |
| | | | | | Error L1 | | Error L2 | |
| | | | | | condition | | condition | |
| | Level 1 | | Level 2 | | [%] | | [%] | |
| | Std | OoP | Std | OoP | Std | OoP | Std | OoP |
| Dist. | [pF] | [pF] | [pF] | [pF] | [%] | [%] | [%] | [%] |
| C0 | 7.016 | 12.263 | 8.7207 | 15.015 | | | | |
| C2 cm | 7.29 | 12.281 | 9.19 | 15.045 | 3.91 | 0.15 | 5.38 | 0.20 |
| C1 cm | 7.46 | 12.295 | 9.5 | 15.07 | 6.33 | 0.26 | 8.94 | 0.37 |
| Ctouch | 8.68 | 12.388 | 10.94 | 15.242 | 23.72 | 1.02 | 25.45 | 1.51 |

Example applications for differential OoP capacitive liquid level measurement according to this Disclosure include: coffee machines (water level), and auto-injectors (drug level).

In summary, the Disclosed system/methodology for capacitive liquid level measurement uses differential out-of-phase (OoP) channel drive to counteract human body capacitance. In example embodiments, a system suitable for capacitive liquid level measurement can include a capacitive sensor and capacitance measurement electronics. The capacitive sensor, disposed adjacent the container, can include symmetrical CHx and CHy capacitor electrodes, each corresponding in height to a range of liquid level measurement. The capacitance measurement electronics can include a CHx channel coupled to the CHx electrode, and a CHy channel coupled to the CHy electrode, and can be configured to measure capacitance associated with the liquid level of the liquid in the container, including: driving the CHx electrode through the CHx channel with a CHx drive signal; driving the CHy electrode through the CHy channel with a CHy drive signal that is substantially 180 degrees out-of-phase with the CHx drive signal; acquiring capacitance measurements through the CHx channel (such as referenced to ground); and converting the capacitance measurements to an analog voltage corresponding to the capacitance associated with the liquid level. The capacitance measurement electronics can be configured to acquire capacitance measurements based on capacitive charge transfer.

In other example embodiments, the capacitive sensor can include a SHLDx shield disposed behind the CHx electrode, and a SHLDy shield disposed behind the CHy electrode, and the capacitance measurement electronics can include a SHLDx driver coupled through a SHLDx output to the SHLDx shield, and a SHLDy driver coupled through a SHLDy output to the SHLDy shield, and can be further configured to drive the SHLDx shield with a SHLDx signal in phase with the CHx electrode channel drive, and drive the SHLDy shield with a SHLDy signal in phase with the CHy electrode. In other example embodiments, the capacitance measurement electronics can be configured as a capacitance-to-digital conversion (CDC) unit, including analog front end (AFE) circuitry, and analog-to-digital conversion (ADC) circuitry, where the AFE is configured to drive the CHx and CHy electrodes through the CHx and CHy channels, and acquire analog capacitance measurements through the CHx channel, and the ADC is configured to convert the capacitance measurements to digital data corresponding to the capacitance associated with the liquid level.

The Disclosure provided by this Description and the Figures sets forth example embodiments and applications illustrating aspects and features of the invention, and does not limit the scope of the invention, which is defined by the claims. Known circuits, functions and operations are not described in detail to avoid obscuring the principles and features of the invention. These example embodiments and applications can be used by ordinarily skilled artisans as a basis for modifications, substitutions and alternatives to construct other embodiments, including adaptations for other applications.

1. A system suitable for capacitive liquid level measurement, comprising
a container containing a liquid at a liquid level;
a capacitive sensor disposed adjacent the container, including symmetrical CHx and CHy capacitor electrodes, each corresponding in height to a range of liquid level measurement; and
capacitance measurement electronics including a CHx channel coupled to the CHx electrode, and a CHy channel coupled to the CHy electrode, and configured to measure capacitance associated with the liquid level of the liquid in the container, including:
driving the CHx electrode through the CHx channel with a CHx drive signal; and
driving the CHy electrode through the CHy channel with a CHy drive signal that is substantially 180 degrees out-of-phase with the CHx drive signal;
acquiring capacitance measurements through the CHx channel; and
converting the capacitance measurements to an analog voltage corresponding to the capacitance associated with the liquid level.

2. The system of claim 1, wherein the capacitance measurement acquired through the CHx channel is referenced to ground.

3. The system of claim 1,
wherein the capacitive sensor further comprises a SHLDx shield disposed behind the CHx electrode, and a SHLDy shield disposed behind the CHy electrode; and
wherein the capacitance measurement electronics
further comprises a SHLDx driver coupled through a SHLDx output to the SHLDx shield, and a SHLDy driver coupled through a SHLDy output to the SHLDy shield, and
is further configured to
drive the SHLDx shield with a SHLDx signal in phase with the CHx electrode channel drive, and
drive the SHLDy shield with a SHLDy signal in phase with the CHy electrode.

4. The system of claim 1, wherein the capacitance measurement electronics comprises a capacitance-to-digital conversion (CDC) unit, including
analog front end circuitry configured to:
drive the CHx and CHy electrodes through the CHx and CHy channels;
acquire analog capacitance measurements through the CHx channel; and
analog-to-digital conversion circuitry configured to convert the capacitance measurements to digital data corresponding to the capacitance associated with the liquid level.

5. The system of claim 4, wherein the capacitance measurements are acquired based on capacitive charge transfer.

6. The system of claim 1, wherein the liquid in the container can be one of: water such as in a coffee machine, and drug level such as in an auto-injector.

7. A circuit suitable for capacitive liquid level measurement of a liquid in a container, the circuit adaptable for use with a capacitive sensor disposed adjacent the container, including CHx and CHy symmetrical capacitor electrodes, each corresponding in height to a range of liquid level measurement, the circuit comprising:
a CHx drive circuitry coupled to the CHx electrode, and configured to drive the CHx electrode through a CHx channel with a CHx drive signal;
a CHy drive circuitry coupled to the CHy electrode, and configured to drive the CHy electrode through the CHy channel with a CHy drive signal that is substantially 180 degrees out-of-phase with the CHx drive signal;
capacitance measurement circuitry configured to measure capacitance associated with the liquid level of the liquid in the container, including:
acquiring capacitance measurements through the CHx channel; and
converting the capacitance measurements to an analog voltage corresponding to the capacitance associated with the liquid level.

8. The circuit of claim 7, wherein the capacitance measurement acquired through the CHx channel is referenced to ground.

9. The system of claim 7, wherein the capacitive sensor includes a SHLDx shield disposed behind the CHx electrode, and a SHLDy shield disposed behind the CHy electrode, and:
wherein the capacitance measurement electronics further comprises a SHLDx driver coupled through a SHLDx output to the SHLDx shield, and a SHLDy driver coupled through a SHLDy output to the SHLDy shield; and
wherein the capacitance measurement electronics is further configured to drive the SHLDx shield with a SHLDx signal in phase with the CHx electrode channel drive, and drive the SHLDy shield with a SHLDy signal in phase with the CHy electrode.

10. The circuit of claim 7, wherein the capacitance measurement electronics comprises a capacitance-to-digital conversion (CDC) unit, including
analog front end circuitry configured to:
drive the CHx and CHy electrodes through the CHx and CHy channels;
acquire analog capacitance measurements through the CHx channel; and
analog-to-digital conversion circuitry configured to convert the capacitance measurements to digital data corresponding to the capacitance associated with the liquid level.

11. The circuit of claim 7, wherein capacitance measurements are acquired based on capacitive charge transfer.

12. The circuit of claim 7, wherein the liquid in the container can be one of: water such as in a coffee machine, and drug level such as in an auto-injector.

13. A method suitable for capacitive liquid level measurement of a liquid in a container, the method adaptable for use with a capacitive sensor disposed adjacent the container, including CHx and CHy symmetrical capacitor electrodes, each corresponding in height to a range of liquid level measurement, the method comprising:
driving the CHx electrode with a CHx drive signal;
driving the CHy electrode with a CHy drive signal that is substantially 180 degrees out-of-phase with the CHx drive signal;
acquiring capacitance measurements through the CHx electrode; and
converting the capacitance measurements to an analog voltage corresponding to the capacitance associated with the liquid level.

14. The method of claim 13, wherein the capacitance measurement acquired through the CHx electrode is referenced to ground.

15. The method of claim 13, wherein the capacitive sensor includes a SHLDx shield disposed behind the CHx electrode, and a SHLDy shield disposed behind the CHy electrode, further comprising
driving the SHLDx shield with a SHLDx signal in phase with the CHx electrode channel drive; and
driving the SHLDy shield with a SHLDy signal in phase with the CHy electrode.

16. The method of claim 13, implemented with a capacitance-to-digital conversion (CDC) unit, including
analog front end circuitry configured to:
drive the CHx and CHy electrodes through the CHx and CHy channels;
acquire analog capacitance measurements through the CHx channel; and
analog-to-digital conversion circuitry configured to convert the capacitance measurements to digital data corresponding to the capacitance associated with the liquid level.

17. The method of claim 13, wherein capacitance measurements acquired based on capacitive charge transfer.

18. The method of claim 13, wherein the liquid in the container can be one of: water such as in a coffee machine, and drug level such as in an auto-injector.
